(19) United States
(12) Patent Application Publication
(10) Pub. No.: US 2025/0303260 A1
(43) Pub. Date: Oct. 2, 2025

(54) METHOD AND SYSTEM FOR RECOMMENDING POSITION OF FOOTBALL PLAYER

(71) Applicant: SPOIT CO., LTD., lncheon (KR)

(72) Inventor: Jung Hyuk KWON, Seoul (KR)

(73) Assignee: SPOIT CO., LTD., lncheon (KR)

(21) Appl. No.: 19/169,062

(22) Filed: Apr. 3, 2025

(30) Foreign Application Priority Data
Mar. 29, 2024 (KR) 10-2024-0042931

(51) Int. Cl. A63B 71/06; G06F 16/28

(52) U.S. Cl. CPC A63B 71/0616; G06F 16/287; A63B 2243/0025

(57) ABSTRACT

Provided is a method performed on a computing device including obtaining a query heatmap representing pass data of a player and a current position of the player, classifying the query heatmap into one of a plurality of clusters by inputting the query heatmap into an artificial intelligence model, and providing the player with information about at least one professional player who is the owner of a reference heatmap classified into the same cluster as the query heatmap and has the same position as the input current position, in which the information about the professional player includes a position played by the professional player, the professional player's strengths and weaknesses, or the professional player's coach, the position played by the professional player further includes a position different from the position of the player, and the reference heatmap represents pass data of the professional player.

### CROSS-REFERENCE TO RELATED APPLICATION

This application is a Continuation application of National Stage Application of PCT International Patent Application No. PCT/KR2025/003693 filed on Mar. 24, 2025, under 35 U.S.C. § 371, which claims priority to Korean Patent Application No. 10-2024-0042931 filed Mar. 29, 2024 which are all hereby incorporated by reference in their entirety.

### BACKGROUND

The present disclosure relates to a method for recommending a position of a football player and providing a guide for improving performance of the player.

In order to determine a position of a football player, the player's physical strength, skills, body type, experience, and game understanding may be considered. For example, a player with high physical strength and fast sprinting ability may be played as an attacker or winger, and a tall player with a large body who has an advantage in aerial ball duels may be suitable as a defender. Based on the player's skill level and understanding of football, it may be determined whether the player can successfully play in a specific position. While goal-scoring ability or dribbling skills are important for the attacker, marking skills and attack transition skills are important for the defender. For example, a player with excellent passing and area control skills may be played as a central midfielder. Considering the player's game experience and performance, it may be determined which position the player's ability would best suit.

However, in modern football, many football players are appearing as “multiplayers” who are not limited to a single position and perform various roles. Players who are active as multiplayers can play the game in multiple positions and can help the game in responding flexibly to various game situations by performing various roles from offensive to defensive roles as needed. For example, a frontline attacker can come down to the defensive line to play defense or play as a winger. Alternatively, a defender may play an offensive role.

Meanwhile, data-based football is playing an increasingly important role in modern football. Game strategies can be improved and player performance can be enhanced based on data. Data-based football is being utilized in tactics, player selection, and use, but currently, there are limitations in relying on the senses and experience of experts when it comes to recommending player positions, and in particular, there are very few cases where artificial intelligence technology is utilized in football games.

### SUMMARY

The present disclosure provides a method for receiving position recommendations using a heatmap generated based on the player's pass data and receiving guidance to improve player performance.

The technical problems to be solved by this embodiment are not limited to the technical problems described above, and other technical problems may be inferred from the embodiments below.

In accordance with an exemplary embodiment of the present invention, there is provided a method performed on a computing device including obtaining a query heatmap representing pass data of a player and a current position of the player, classifying the query heatmap into one of a plurality of clusters by inputting the query heatmap into an artificial intelligence model, and providing the player with information about at least one professional player who is the owner of a reference heatmap classified into the same cluster as the query heatmap and has the same position as the input current position, in which the information about the professional player includes a position played by the professional player, the professional player's strengths and weaknesses, or the professional player's coach, the position played by the professional player further includes a position different from the position of the player, and the reference heatmap represents pass data of the professional player.

Various reference heatmaps of professional players may be classified into the plurality of clusters based on the artificial intelligence model and may be stored in a database by being matched with the information about the professional player.

### BRIEF DESCRIPTION OF THE DRAWINGS

Exemplary embodiments can be understood in more detail from the following description taken in conjunction with the accompanying drawings, in which:

FIG. 1 illustrates a system for providing position recommendation information to a football player according to an embodiment;

FIG. 2 illustrates a flowchart of a method for providing position recommendation information to a football player according to an embodiment;

FIG. 3 illustrates various heatmaps according to an embodiment;

FIG. 4 illustrates an artificial intelligence model for classifying heatmaps into a plurality of clusters according to an embodiment; and

FIG. 5 illustrates a part of a database according to an embodiment.

### DETAILED DESCRIPTION OF EMBODIMENTS

Below, several embodiments will be clearly and in detail described with reference to the accompanying drawings so that those of ordinary knowledge in the technical field to which the present invention belongs (hereinafter, referred to as those skilled in the art) can easily implement the invention.

Hereinafter, players are people with experience playing in many football games and may include both amateurs and professional players. The players want to strengthen their abilities as multiplayers by being recommended a position other than their current main positions, and want to improve their performance by being recommended an appropriate coach.

“Heatmap” represents data obtained by accumulating locations where a specific player moves within a stadium and visualizing their distribution and frequency. The bluer the color at a specific position of the heatmap, the lower the frequency at which the player was at that position, and the redder the color, the higher the frequency at which the player was at that position, but the heatmap is not limited thereto.

Hereinafter, the heatmap may be data obtained by visualizing the locations where a specific player was involved in a pass. The locations involved in the pass means positions within the stadium at the moment when a specific player gives or receives a pass. In the heatmap in which such pass positions are recorded, the moment when a player most actively interacts with the ball may be recorded.

The methods below may be performed on at least one processor or computing device.

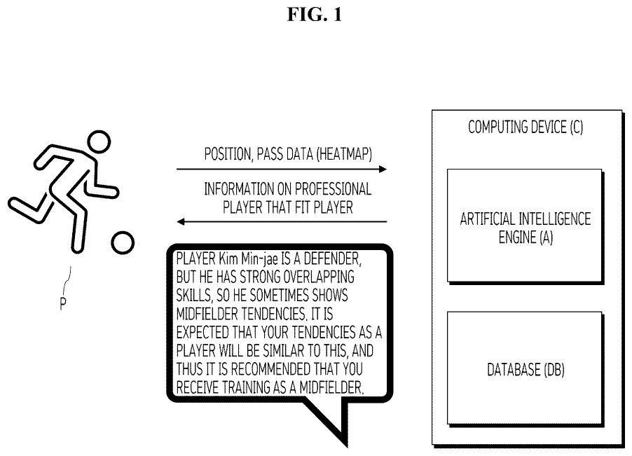

Referring to FIG. 1, a player P may provide his/her current position and pass data (or heatmap) to a computing device C and obtain information on at least one professional player who matches his/her style or can be helpful from the computing device C. The computing device C may include, but is not limited to, a PC, a smartphone, a tablet PC, etc.

The computing device C may include an artificial intelligence engine A and a database DB. The database DB may store heatmaps of professional players, information about professional players (strengths and weaknesses of professional players, information on coaching staff of professional players, styles of professional players), etc. The heatmaps of professional players may include a heatmap generated for each game played by the professional player. A single professional player may have multiple heatmaps. Each of the heatmaps may be classified into one of a plurality of clusters by the artificial intelligence engine A.

The artificial intelligence engine A may classify a specific heatmap into one of multiple clusters or classify multiple heatmaps into multiple clusters based on machine learning techniques. The artificial intelligence engine A may determine heatmaps (meaning heatmaps of professional players) similar to the heatmap input by the player P or other heatmaps belonging to the same cluster as the cluster into which the input heatmap is classified, and provide information about at least one professional player matching the player P based on the determined heatmap of at least one professional player. The heatmap that the player P inputs to the computing device C may be referred to as a query heatmap, and the heatmap of the professional players determined to be similar to the query heatmap may be referred to as a reference heatmap.

The computing device C is illustrated as including the artificial intelligence engine A and the database DB, but at least a portion of the artificial intelligence engine A (e.g., a neural network) may be external (e.g., a server), or at least a portion of the database DB may be external (e.g., a server), and the computing device C may exchange data with an external server based on a wired or wireless communication interface.

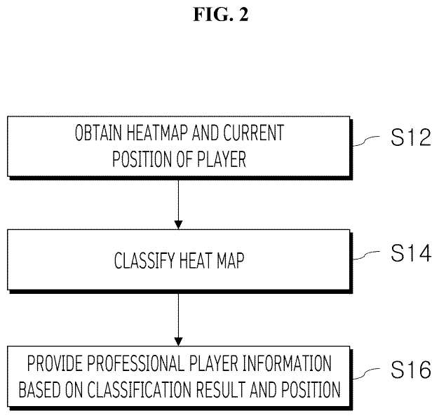

FIG. 2 illustrates a flowchart of a method for providing position recommendation information to a football player according to an embodiment.

Referring to FIG. 2, in step S12, the computing device C may obtain a heatmap and current position of the player P.

Pass data may mean data containing starting and ending locations of a pass. The starting and ending locations of the pass may include respective starting location and ending location of the pass. A pass is a pass involving the player P and refers to passes given or received by the player P. The starting and ending locations may each include location information on a two-dimensional stadium. The location information may be information that is converted into location information on a two-dimensional stadium by the computing device C through perspective transformation using a football game video, but is not limited thereto.

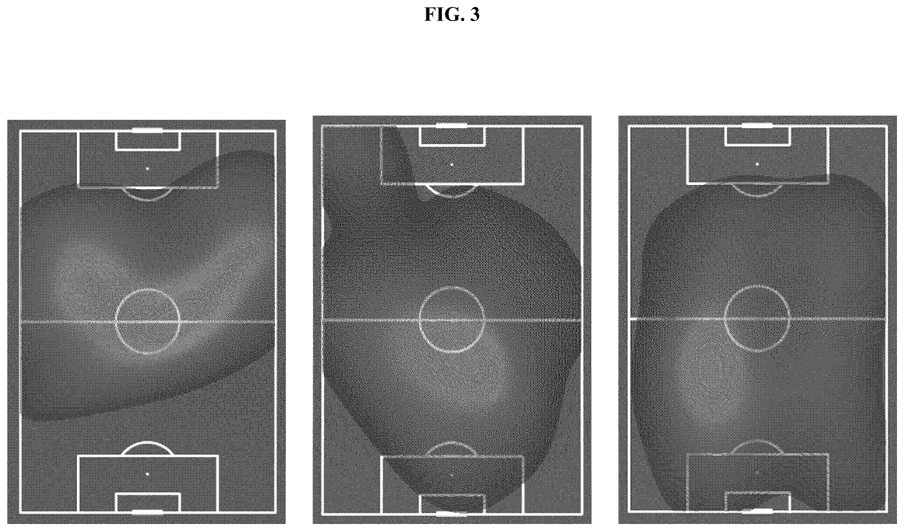

According to an embodiment, pass data may be expressed as a heatmap. The player P may input a heatmap corresponding to his/her pass data into the computing device C, or the computing device C may generate a heatmap based on the pass data input from the player P. FIG. 3 illustrates various heatmaps according to an embodiment.

Input position information is football positions held by the player P in football. According to an embodiment, the positions may include, but are not limited to, a center forward (CF), a left winger (LW), a right winger (RW), a midfielder (MF), an attacking midfielder (AM), a left midfielder (LM), a right midfielder (RM), a defensive midfielder (DM), a defender (DF), a central midfielder (CM), a full back (FB), a wingback (WB), a left wing back (LWB), a right wing back (RWB), etc. An upper category of CF, LW, and RW is ‘Forward (FW)’, an upper category of AM, CM, and DM is ‘Midfielder (MF)’, and an upper category of CB, FB, and WB is ‘Defender (DF)’. According to an embodiment, the input position of the player P may be at least one of lower category positions CF, LW, RW, AM, LM, RM, DM, CM, FB, WB, LWB, and RWB or the upper category positions FW, MF, and DF. The input position may be the position played by the player P in the game in which an input heatmap was generated.

In step S14, the computing device C may classify the input heat map of the player P into one of a plurality of clusters. The artificial intelligence engine A may search for heat maps of professional player(s) similar to the input heat map based on the machine learning technique. The artificial intelligence engine A may classify the heat maps of the professional players into a plurality of clusters and classify the heat map of the player P into one of the plurality of clusters. The artificial intelligence engine A may classify the heat map of the player P and the heat map of the professional players into a plurality of clusters based on machine learning. According to an embodiment, the heat maps of the professional players may be stored in the database DB.

According to an embodiment, the artificial intelligence engine A may be trained to classify the plurality of heat maps into one of a plurality of clusters based on the machine learning technique by using the plurality of heat maps as training data. Machine learning techniques may include support vector machine (SVM), Random forest, Naive Bayes, adaptive boosting: (AdaBoost), gradient boosting, K-means clustering, artificial neural network, etc. For example, the artificial intelligence engine may generate output results using an artificial neural network in the form of a convolution neural network (CNN) that includes an input layer, a hidden layer, and an output layer, or an artificial neural network in the form of a long short-term model (LSTM), which is a type of a recurrent neural network (RNN). The machine learning techniques may include supervised learning and unsupervised learning.

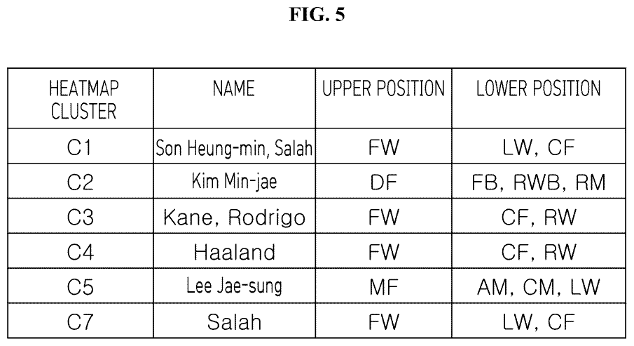

According to an embodiment, information on various professional players and heat maps of professional players may be stored in the database DB. According to an embodiment, the heat maps may be matched with information on the cluster to which each heat map belongs and stored in the database (DB). The Information on the professional players may include positions. The positions may include upper category positions and at least one lower category position of professional players. Referring to FIG. 5, the database DB may store “Kim Min-jae, DF, FB, RWB, RM, C2”. C2 indicates that the heat map of player Kim Min-jae belongs to cluster C2. Of course, since there is not only one heat map of player Kim Min-jae, all of heat maps of player Kim Min-jae may not belong to a single cluster C2. In contrast, heat maps of various players may belong to a single cluster. For example, heat maps of player Son Heung-min and player Salah may belong to cluster C1.

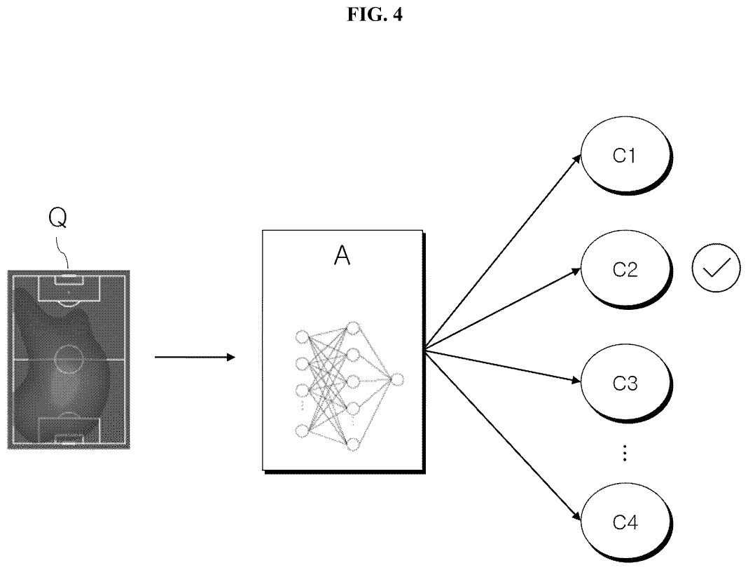

For example, in step S14, a heat map Q of the player P may be determined to belong to the cluster C2 (see FIG. 4).

In step S16, information on at least one professional player who is the owner of the reference heatmap classified into the same cluster as the heatmap of the player P and has the same position as the current position of the input player P may be provided to the player P. According to an embodiment, the computing device C may search for a professional player matching the player P based on the position of the upper category. For example, when the player P inputs RWB, the professional players belonging to DF, which is the upper category of the input position, may be determined as the professional players having the same position as the player P. For example, when the player P who played with the position of RWB inputs his/her heat map in step S12 and the computing device C classifies the heat map of the player P into the cluster C2 in step S14, the player Kim Min-jae may be provided as a professional player who matches the player P. This is because the upper category positions of the player P and the player Kim Min-jae are both DF and are the same.

Information about a professional player provided to the player P may include the professional player's position, strengths, and weaknesses, training information about what kind of training the professional player receives, information about the coaching staff coaching the professional player, and styles, etc. For example, information about the professional player provided to the player P may be “Player Kim Min-jae is a defender, but he has strong overlapping skills, so he sometimes shows midfielder tendencies. It is expected that your tendencies as a player will be similar to this, and thus it is recommended that you receive training as a midfielder.”

A method for receiving position recommendations using a heatmap generated based on the player's pass data and receiving guidance to improve player performance.

The descriptions are intended to provide exemplary configurations and operations for implementing the present invention. The technical idea of the present invention will include not only the embodiments described above, but also implementations that may be obtained by simply changing or modifying the embodiments described above. In addition, the technical idea of the present invention will also include implementations that may be easily achieved by changing or modifying the embodiments described above in the future.

Although the method and system for recommending position of football player have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A method performed on a computing device, comprising:
obtaining a query heatmap representing pass data of a player and a current position of the player;
classifying the query heatmap into one of a plurality of clusters by inputting the query heatmap into an artificial intelligence model; and
providing the player with information about at least one professional player who is the owner of a reference heatmap classified into the same cluster as the query heatmap and has the same position as the input current position,
wherein the information about the professional player includes a position played by the professional player, the professional player's strengths and weaknesses, or the professional player's coach, the position played by the professional player further includes a position different from the position of the player, and the reference heatmap represents pass data of the professional player.

2. The method of claim 1, wherein various reference heatmaps of professional players are classified into the plurality of clusters based on the artificial intelligence model and may be stored in a database by being matched with the information about the professional player.
